(19) United States
(12) Patent Application Publication
(10) Pub. No.: US 2009/0129547 A1
(43) Pub. Date: May 21, 2009

(54) PORTABLE DUAL-MODE DIGITAL X-RAY DETECTOR AND METHODS OF OPERATION OF SAME

(75) Inventors: Kadri Nizar Jabri, Waukesha, WI (US); Ferry Tamtoro, Oconomowoc, WI (US); Rajeev Ramankutty Marar, Waukesha, WI (US); Rowland Frederick Saunders, Hartland, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/941,397

(22) Filed: Nov. 16, 2007

(51) Int. Cl. H05G 1/58

(52) U.S. Cl. 378/115

(57) ABSTRACT

A portable dual-mode digital X-ray detector configured to operate in an integrated mode for use in direct digital radiography (DDR) and in non-integrated mode for use in computed radiography (CR). The portable dual-mode X-ray detector comprising a switching mechanism for switching the detector between an integrated mode and a non-integrated mode, a triggering mechanism for use in the non-integrated mode, a communications interface for use in the integrated mode, and at least one memory module for storing image data. The disclosure further includes the methods of operation of the portable dual-mode digital X-ray detector in the integrated mode for use in direct digital radiography (DDR) and in the non-integrated mode for use in computed radiography (CR).

### BACKGROUND OF THE INVENTION

This disclosure relates generally to imaging systems and methods, and more particularly to a portable dual-mode digital X-ray detector that is capable of being used with any X-ray source of an imaging system, and operating in an integrated mode and a non-integrated mode.

Different imaging modalities use different types of detectors to detect emitted, transmitted or reflected energy from an imaging source. X-rays are one type of energy detected by a detector. There are different types of X-ray imaging systems that use different types of X-ray detectors. In digital radiographic systems, the use of portable digital detectors has been increasing considerably due to their convenience, superior workflow and high image quality. However, portable digital detectors currently need to be coupled to a digital imaging system in order to function. Portable digital flat panel detectors used in direct digital radiography (DDR) need to be integrated with the X-ray source, and operate in an integrated mode. Even detectors that do not need an integrated X-ray source and operate in a non-integrated mode, such as those used in computed radiography (CR), still need to be coupled to a processing and/or display workstation. Even after the decreasing the cost of portable digital detectors, many healthcare institutions are deciding to maintain their use of computed radiography (CR) in addition to direct digital radiography (DDR). This requires the use of a separate detector for CR and a separate detector for DDR.

Therefore, there is a need for a portable dual-mode digital X-ray detector configured to be operable in both an integrated mode for use in DDR and a non-integrated mode for use in CR, in a manner similar to a CR imaging plate.

### BRIEF DESCRIPTION OF THE INVENTION

In an embodiment, a portable dual-mode X-ray detector comprising a switching mechanism for switching the detector between an integrated mode and a non-integrated mode; a triggering mechanism for use in the non-integrated mode; a communications interface for use in the integrated mode; and at least one memory module for storing image data.

In an embodiment, a radiography system comprising an X-ray source; a dual-mode portable X-ray detector capable of operating in an integrated mode and a non-integrated mode; and a system controller coupled to the X-ray source and the dual-mode portable X-ray detector for controlling operation of the X-ray source and the dual-mode portable X-ray detector; wherein the dual-mode portable X-ray detector is operating in the integrated-mode.

In an embodiment, a radiography system comprising an X-ray source; a dual-mode portable X-ray detector capable of operating in an integrated mode and a non-integrated mode; and a system controller coupled to the X-ray source for controlling operation of the X-ray source; wherein the dual-mode portable X-ray detector is operating in the non-integrated-mode.

In an embodiment, a method of operation of a portable dual-mode X-ray detector in an integrated mode comprising switching the portable dual-mode digital X-ray detector to an integrated mode; positioning a patient, the detector, and an X-ray source for an X-ray exposure; initiating the X-ray exposure; capturing image data in the detector; and transferring the captured image data to a workstation and/or a server for processing, viewing and/or archiving.

In an embodiment, a method of operation of a portable dual-mode X-ray detector in a non-integrated mode comprising switching the portable dual-mode digital X-ray detector to a non-integrated mode; positioning a patient, the detector, and an X-ray source for an X-ray exposure; initiating the X-ray exposure; capturing image data in the detector; storing the captured image data in at least one memory module; reading the captured image data stored on the at least one memory module; and transferring the image data read from the at least one memory module to a workstation and/or a server for processing, viewing and/or archiving.

Various other features, aspects, and advantages will be made apparent to those skilled in the art from the accompanying drawings and detailed description thereof.

### BRIEF DESCRIPTION OF THE DRAWINGS

FIG. 1 is a block diagram of an exemplary embodiment of a radiography system with a portable dual-mode digital X-ray detector operating in an integrated mode;

FIG. 2 is a block diagram of an exemplary embodiment of a radiography system with a portable dual-mode digital X-ray detector operating in a non-integrated mode;

FIG. 3A is a schematic diagram of an exemplary embodiment of a portable dual-mode digital X-ray detector;

FIG. 3B is a schematic diagram of an exemplary embodiment of a portable dual-mode digital X-ray detector;

FIG. 4 is a schematic diagram of an exemplary embodiment of a removable memory module with a unique identifier;

FIG. 5 is a schematic diagram of an exemplary embodiment of a removable memory module with a unique identifier;

FIG. 6 is a flow diagram of an exemplary embodiment of a method of operation of a portable dual-mode digital X-ray detector in an integrated mode; and

FIG. 7 is a flow diagram of an exemplary embodiment of a method of operation of a portable dual-mode digital X-ray detector in a non-integrated mode.

### DETAILED DESCRIPTION OF THE INVENTION

In various embodiments, a portable dual-mode digital X-ray detector is disclosed. The portable dual-mode digital X-ray detector is configured to operate in an integrated mode for use in direct digital radiography (DDR) and in non-integrated mode for use in computed radiography (CR), in a manner similar to a CR imaging plate. Integrated mode refers to a portable dual-mode digital X-ray detector that is integrated with an X-ray source through a system controller, while non-integrated mode refers to a stand-alone portable dual-mode digital X-ray detector that is not integrated with an X-ray source or a system controller. In an exemplary embodiment, the portable dual-mode digital X-ray detector is configured to be used with any X-ray source without the need to be coupled to an X-ray source or a system controller.

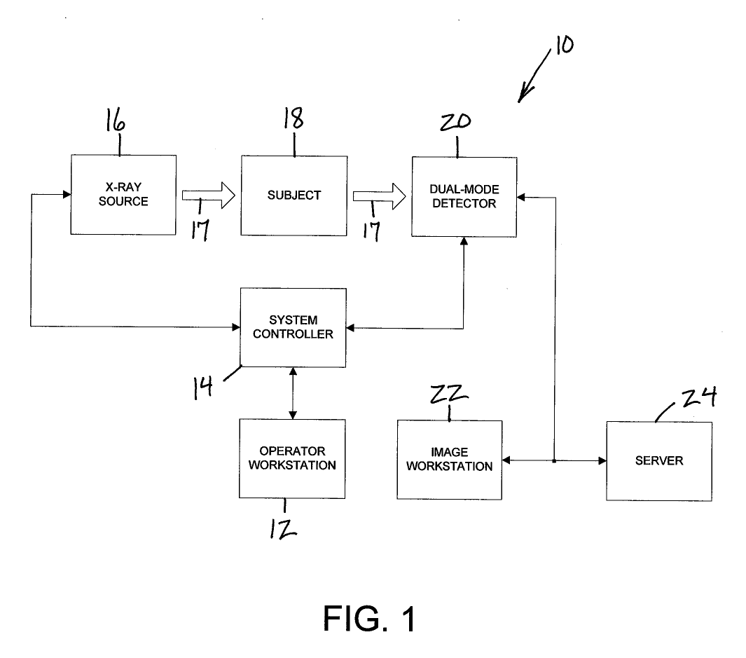

Referring now to the drawings, FIG. 1 illustrates a block diagram of an exemplary embodiment of a radiography system 10 with a portable dual-mode digital X-ray detector 20 operating in an integrated mode for use in direct digital radiography (DDR). DDR provides an immediate conversion of X-ray radiation intensity into digital image information. Exposure and image formation happen substantially simultaneously. In an exemplary embodiment, the radiography system 10 may be a digital radiography system. In an exemplary embodiment, the portable dual-mode digital X-ray detector 20 may be configured to operate as a digital flat panel detector that provides an immediate conversion of X-ray radiation intensity into digital image information.

The radiography system 10 includes an operator workstation 12 coupled to a system controller 14 for controlling operation of an X-ray source 16 and the portable dual-mode digital X-ray detector 20. The operator workstation 12 is coupled to the system controller 14 through a wired or wireless communications interface. The wired communications interface may include a cable or tether connecting the operator workstation 12 to the system controller 14. The wireless communications interface may be implemented through a wireless communications protocol. The system controller 14 is coupled to the X-ray source 16 and the portable dual-mode digital X-ray detector 20 through a wired or wireless communications interface. The wired communications interface may include a cable or tether connecting the system controller 14 to the X-ray source 16 and a cable or tether connecting the system controller 14 to the portable dual-mode digital X-ray detector 20. The wireless communications interface may be implemented through a wireless communications protocol. The X-ray source 16 produces an X-ray beam 17 that passes through a subject 18 and impacts the portable dual-mode digital X-ray detector 20 producing images of the subject 18. The portable dual-mode digital X-ray detector 20 converts X-ray photons received on its surface to lower energy photons, and subsequently to electric signals, which are acquired and processed to reconstruct an image of internal anatomy within the subject 18.

The portable dual-mode digital X-ray detector 20 is configured to receive data transfer timing signals from the system controller 14. The data transfer timing signals from the system controller 14 may either initiate or terminate image capture in the portable dual-mode digital X-ray detector 20. The captured images may be viewed in real-time on a display coupled to the operator workstation 12, an image workstation 22 or archived on a server 24.

The portable dual-mode digital X-ray detector 20 may be coupled to a range of external devices via a wired or wireless communications interface. The wired communications interface may include a cable or tether connecting the portable dual-mode digital X-ray detector 20 to the external devices. The wireless communications interface may be implemented through a wireless communications protocol. Such devices may include, for example, an image workstation 22 for processing or reprocessing images, viewing images, and so forth. A display or a printer may be coupled to the image workstation 22. In general, these external devices may be local to the portable dual-mode digital X-ray detector 20, or may be remote from the portable dual-mode digital X-ray detector 20, such as elsewhere within a healthcare facility, or in an entirely different location, linked to the portable dual-mode digital X-ray detector 20 via one or more configurable networks, such as the Internet, intranet, virtual private networks, and so forth. It should be further noted that the portable dual-mode digital X-ray detector 20 may also be coupled to a server 24, such as a picture archiving and communications system (PACS) through a wired or wireless communications interface. The wired communications interface may include a cable or tether connecting the portable dual-mode digital X-ray detector 20 to the server 24. The wireless communications interface may be implemented through a wireless communications protocol. Such a PACS may be coupled to remote clients, such as a radiology department information system (RIS) or hospital information system (HIS), or to an internal or external network, so that others at different locations may gain access to image data.

The system controller 14 may supply both power and control signals for imaging examination sequences. In general, system controller 14 commands operation of the radiography system 10 to execute examination protocols and to process acquired image data. The system controller 14 may also include signal processing circuitry, based on a general purpose or application-specific computer, associated memory circuitry for storing programs and routines executed by the computer, as well as configuration parameters and image data, interface circuits, and so forth.

The system controller 14 may further include at least one processor designed to coordinate operation of the X-ray source 16 and portable dual-mode digital X-ray detector 20, and to process acquired image data. The at least one processor may carry out various functionality in accordance with routines stored in the associated memory circuitry. The associated memory circuitry may also serve to store configuration parameters, operational logs, raw and/or processed image data, and so forth. In an exemplary embodiment, the system controller 14 may include at least one image processor to process acquired image data.

The system controller 14 may further include interface circuitry that permits an operator or user to define imaging sequences, determine the operational status and health of system components, and so-forth. The interface circuitry may allow external devices to receive images and image data, and command operation of the radiography system, configure parameters of the system, and so forth.

The system controller 14 may be coupled to a range of external devices via a wired or wireless communications interface. The wired communications interface may include a cable or tether connecting the system controller 14 to the external devices. The wireless communications interface may be implemented through a wireless communications protocol. Such devices may include, for example, the operator workstation 12 for interacting with the image acquisition components, processing or reprocessing images, viewing images, and so forth. A display or a printer may be coupled to the operator workstation 12 through wired or wireless communications interfaces. The wired communications interface may include a cable or tether connecting the operator workstation 12 to a display or a printer. The wireless communications interface may be implemented through a wireless communications protocol. In general, these external devices may be local to the system controller 14, or may be remote from the system controller 14, such as elsewhere within a healthcare facility, or in an entirely different location, linked to the system controller 14 via one or more configurable networks, such as the Internet, intranet, virtual private networks, and so forth.

In an exemplary embodiment, the portable dual-mode digital X-ray detector 20 may be powered with a battery. The battery may be removable, replaceable and/or rechargeable.

In an exemplary embodiment, the portable dual-mode digital X-ray detector 20 may be powered through a dedicated power line cable that may be plugged into a standard wall socket. In this embodiment, the portable dual-mode digital X-ray detector 20 includes the necessary electronic circuitry for power transformation and power conversion.

In an exemplary embodiment, the portable dual-mode digital X-ray detector 20 may be powered from the radiography system 10 it is coupled to.

In an exemplary embodiment, the portable dual-mode digital X-ray detector 20 may be physically connected to the radiography system through a wired communications interface using a cable or tether. In this embodiment, the image data from the portable dual-mode digital X-ray detector 20 may be sent through the wired communications interface and the cable or tether to the image workstation 22 and/or server 24.

In an exemplary embodiment, the portable dual-mode digital X-ray detector 20 may be coupled to the radiography system through a wireless communications interface. In this embodiment, the image data from the portable dual-mode digital X-ray detector 20 may be sent to the image workstation 22 and/or server 24 through a wireless communications protocol.

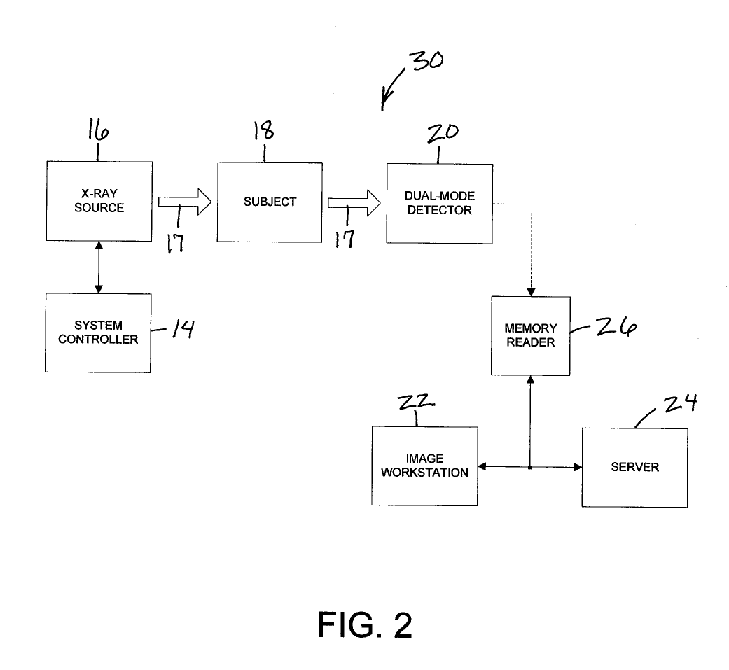

FIG. 2 illustrates a block diagram of an exemplary embodiment of a radiography system 30 with a portable dual-mode digital X-ray detector 20 operating in a non-integrated mode for use in computed radiography (CR). In an exemplary embodiment, the radiography system 10 may be a digital radiography system. In an exemplary embodiment, the portable dual-mode digital X-ray detector 20 is configured to operate as a digital flat panel detector that converts X-ray radiation intensity into digital image information. The digital image information is stored on at least one memory module within the portable dual-mode digital X-ray detector 20. The at least one memory module may hold one or more images from one or more patients.

The radiography system 30 includes a system controller 14 coupled to the X-ray source 16 for controlling operation of an X-ray source 16. In an exemplary embodiment, the system controller 14 may include a user interface for inputting X-ray source settings by an operator or user. The system controller 14 may be coupled to the X-ray source 16 through a wired or wireless communications interface. The wired communications interface may include a cable or tether connecting the system controller 14 to the X-ray source 16. The wireless communications interface may be implemented through a wireless communications protocol. The X-ray source 16 produces an X-ray beam 17 that passes through a subject 18 and impacts the portable dual-mode digital X-ray detector 20 producing images of the subject 18. The portable dual-mode digital X-ray detector 20 converts X-ray photons received on its surface to lower energy photons, and subsequently to electric signals, which are acquired and stored on at least one memory module within the portable dual-mode digital X-ray detector 20 to be read and processed to reconstruct an image of internal anatomy within the subject 18.

In an exemplary embodiment, the at least one memory module may be removable from the portable dual-mode digital X-ray detector 20. In this embodiment, the at least one memory module may be removed from the portable dual-mode digital X-ray detector 20 and taken to a memory reader 26 to be read.

In an exemplary embodiment, the at least one removable memory module may include a unique identifier that will enable it to be associated with a patient whose images are stored on the at least one removable memory module.

In an exemplary embodiment, the at least one memory module may be fixed within the portable dual-mode digital X-ray detector 20. In this embodiment, the at least one memory module may be coupled to the memory reader 26 to be read through a wired or wireless communications interface. The wired communications interface may include a cable or tether connecting the at least one memory module within the portable dual-mode digital X-ray detector 20 to the memory reader 26. The wireless communications interface may be implemented through a wireless communications protocol.

The memory reader 26 reads the image data on the at least one memory module. The memory reader 26 may be coupled to a range of external devices via a wired or wireless communications interface. The wired communications interface may include a cable or tether connecting the portable dual-mode digital X-ray detector 20 to the external devices. The wireless communications interface may be implemented through a wireless communications protocol. Such devices may include, for example, an image workstation 22 for processing or reprocessing images, viewing images, and so forth. A display or a printer may be coupled to the image workstation 22. In general, these external devices may be local to the portable dual-mode digital X-ray detector 20, or may be remote from the portable dual-mode digital X-ray detector 20, such as elsewhere within a healthcare facility, or in an entirely different location, linked to the portable dual-mode digital X-ray detector 20 via one or more configurable networks, such as the Internet, intranet, virtual private networks, and so forth. It should be further noted that the portable dual-mode digital X-ray detector 20 may also be coupled to a server 24, such as a picture archiving and communications system (PACS) through a wired or wireless communications interface. The wired communications interface may include a cable or tether connecting the portable dual-mode digital X-ray detector 20 to the server 24. The wireless communications interface may be implemented through a wireless communications protocol. Such a PACS may be coupled to remote clients, such as a radiology department information system (RIS) or hospital information system (HIS), or to an internal or external network, so that others at different locations may gain access to image data.

In an exemplary embodiment, the portable dual-mode digital X-ray detector 20 may be powered with a battery. The battery may be removable, replaceable and/or rechargeable.

In an exemplary embodiment, the portable dual-mode digital X-ray detector 20 may be powered through a dedicated power line cable that may be plugged into a standard wall socket. In this embodiment, the portable dual-mode digital X-ray detector 20 includes the necessary electronic circuitry for power transformation and power conversion.

In an exemplary embodiment, the portable dual-mode digital X-ray detector 20 includes a triggering mechanism that functions to initiate and terminate image capture in the portable dual-mode digital X-ray detector 20. Image capture is initiated in the portable dual-mode digital X-ray detector 20 by the triggering mechanism that is configured to detect X-ray radiation. In an exemplary embodiment, the triggering mechanism detects incoming X-ray radiation above a pre-determined threshold value and initiates image capture. The triggering mechanism terminates image capture when it no longer detects any X-ray radiation above the pre-determined threshold value. In an exemplary embodiment, the X-ray source 16 emits a pre-configuration pulse of X-ray radiation just prior to an X-ray exposure that is detected by the triggering mechanism. The triggering mechanism initiates image capture when it detects the pre-configuration pulse of X-ray radiation from the X-ray source 16. The triggering mechanism terminates image capture when it no longer detects any X-ray radiation.

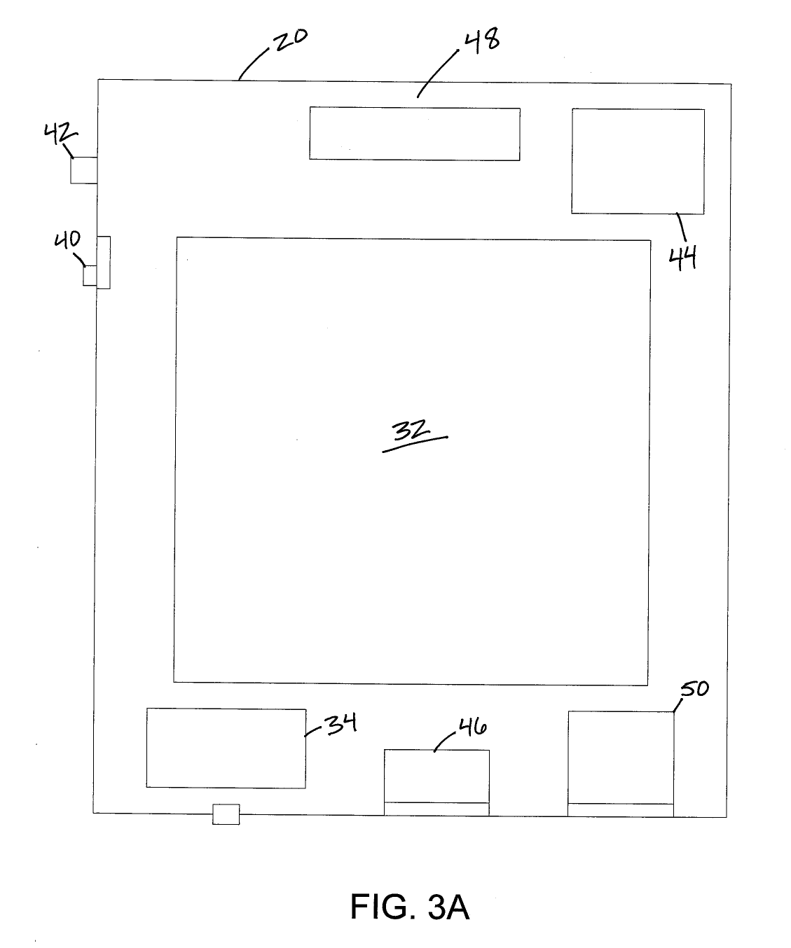

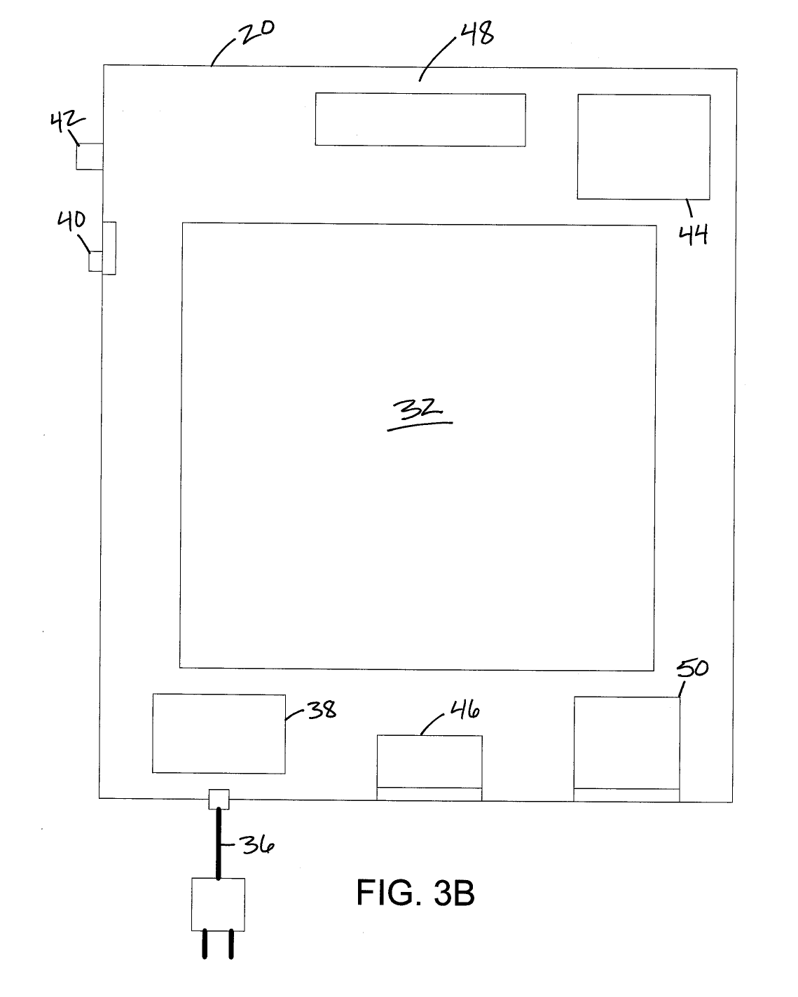

FIGS. 3A and 3B illustrate schematic diagrams of exemplary embodiments of portable dual-mode digital X-ray detectors 20. The portable dual-mode digital X-ray detector 20 is configured to operate in an integrated mode for use in direct digital radiography (DDR) and in a non-integrated mode for use in computed radiography (CR). The portable dual-mode digital X-ray detector 20 is configured to be used with both stand-alone X-ray sources, such as in CR, and integrated X-ray sources, such as in DDR.

The portable dual-mode digital X-ray detector 20 includes an X-ray detection area 32, a power source 34 (FIG. 3A), 38 (FIG. 3B), a switching mechanism 40, a triggering mechanism 44 used in the non-integrated mode, a communications interface 46 used in the integrated mode, and at least one memory module 50.

In an exemplary embodiment, the X-ray detection area 32 may be similar to that found in a digital flat panel detector. The X-ray detection area 32 comprises an amorphous silicon photodiode array deposited on a glass substrate. A cesium iodide (CsI) scintillator is deposited on top of the amorphous silicon photodiode array. The CsI scintillator is designed to convert incident X-ray photons into light photons. The light photons are then channeled toward the amorphous silicon photodiode array where the charge of each photodiode is depleted in proportion to the amount of light it receives. The electronic charge required to recharge each photodiode is then read by electronics and converted into digital image data.

In an exemplary embodiment, the power source 34, illustrated in FIG. 3A, may be a battery. The battery may be a removable, replaceable and/or rechargeable. In an exemplary embodiment, the power source 38, illustrated in FIG. 3B, may be through a dedicated power line cable 36 that may be plugged into a standard wall socket. In this embodiment, the power source 38 includes the necessary electronic circuitry for power transformation and power conversion. In an exemplary embodiment, when the portable dual-mode digital X-ray detector 20 is in the integrated mode, the portable dual-mode digital X-ray detector 20 may be powered from the radiography system it is coupled to.

The switching mechanism 40 is configured to allow a user to switch between either the integrated mode and the non-integrated mode. In an exemplary embodiment, the portable dual-mode digital X-ray detector 20 may also include an indicator 42 that indicates to the user the mode the portable dual-mode digital X-ray detector 20 is in. In an exemplary embodiment, the indicator 42 may be a visual indicator such as a light emitting diode (LED). In an exemplary embodiment, the indicator 42 may be a non-visual indicator such as an audible indicator. In an exemplary embodiment, the switching mechanism is implemented through a manual switch. In an exemplary embodiment, the switching mechanism function of switching between the integrated mode and the non-integrated mode may be implemented automatically. In this embodiment, the portable dual-mode digital X-ray detector 20 automatically determines what mode to operate in and automatically switches to that mode. For example, when a portable dual-mode digital X-ray detector 20 is coupled or tethered to a DDR system, the portable dual-mode digital X-ray detector 20 automatically switches to the integrated mode, and when the portable dual-mode digital X-ray detector 20 is uncoupled or unplugged from the DDR system, the portable dual-mode digital X-ray detector 20 automatically switches to the non-integrated mode, unless a user overrides this automatic switching mechanism by using the manual switching mechanism.

The triggering mechanism 44 may be used when the portable dual-mode digital X-ray detector 20 is in the non-integrated mode. The triggering mechanism 44 is configured to initiate and terminate image capture in the portable dual-mode digital X-ray detector 20 by detecting X-ray radiation. The triggering mechanism 44 should be facing the X-ray source during an X-ray exposure. In an exemplary embodiment, the triggering mechanism detects incoming X-ray radiation above a pre-determined threshold value and initiates image capture. The triggering mechanism terminates image capture when it no longer detects any X-ray radiation above the pre-determined threshold value. In an exemplary embodiment, the X-ray source 16 emits a pre-configuration pulse of X-ray radiation just prior to an X-ray exposure that is detected by the triggering mechanism. The triggering mechanism initiates image capture when it detects the pre-configuration pulse of X-ray radiation from the X-ray source 16. The triggering mechanism terminates image capture when it no longer detects any X-ray radiation. In an exemplary embodiment, the triggering mechanism 44 may be based on a separate photodiode or photodiode array. In an exemplary embodiment, the triggering mechanism 44 may be based on a separate phosphor unit. In an exemplary embodiment, the triggering mechanism 44 may be based on a signal from the portable dual-mode digital X-ray detector 20 itself. In an exemplary embodiment, the X-ray detection area 32 may be used as the triggering mechanism, instead of the separate triggering mechanism 44.

The communications interface 46 may be used when the portable dual-mode digital X-ray detector 20 is in the integrated mode. The communications interface 46 may be a wired communications interface or a wireless communications interface. In an exemplary embodiment, the portable dual-mode digital X-ray detector 20 may be physically connected to the radiography system through a wired communications interface, such as a through a cable or tether. In this embodiment, the image data from the portable dual-mode digital X-ray detector 20 may be sent to an operator workstation 12, image workstation 22 and/or server 24 through a cable or tether using the wired communications interface. In an exemplary embodiment, the portable dual-mode digital X-ray detector 20 may be coupled to the radiography system through a wireless communications interface. In this embodiment, the image data from the portable dual-mode digital X-ray detector 20 may be sent to an operator workstation 12, image workstation 22 and/or image server 24 using a wireless communications protocol.

The at least one memory module 50 may be used to store digital image data from the portable dual-mode digital X-ray detector 20 after an image acquisition. The at least one memory module 50 may store data for one or more images from one or more patients. In an exemplary embodiment, the at least one memory module 50 may be removable. In this embodiment, the at least one memory module 50 containing image data may be removed and taken to a memory reader to read the contents of the at least one memory module 50 in order to generate viewable images. In an exemplary embodiment, the at least one removable memory module 50 may include a unique identifier that will enable it to be associated with a patient whose images are stored on the at least one removable memory module 50. In an exemplary embodiment, the unique identifier may be a barcode, radio frequency identification (RFID) transponder or tag, or other unique identifier. In an exemplary embodiment, the at least one memory module 50 may be fixed within the portable dual-mode digital X-ray detector 20. In this embodiment, the at least one memory module may be coupled to the memory reader to be read through a wired or wireless communications interface. In an exemplary embodiment, the at least one memory module 50 may be used as a backup for imaging data or in an alternative workflow for portable dual-mode digital X-ray detectors used in DDR. In an exemplary embodiment, the portable dual-mode digital X-ray detector 20 may also include a handle 48 for easy handling and carrying.

In an exemplary embodiment, a plurality of removable memory modules 50 may be inserted into the portable dual-mode digital X-ray detector 20 in order to allow capture of a plurality of images with the portable dual-mode digital X-ray detector 20 before reading the image data from the plurality of removable memory modules 50.

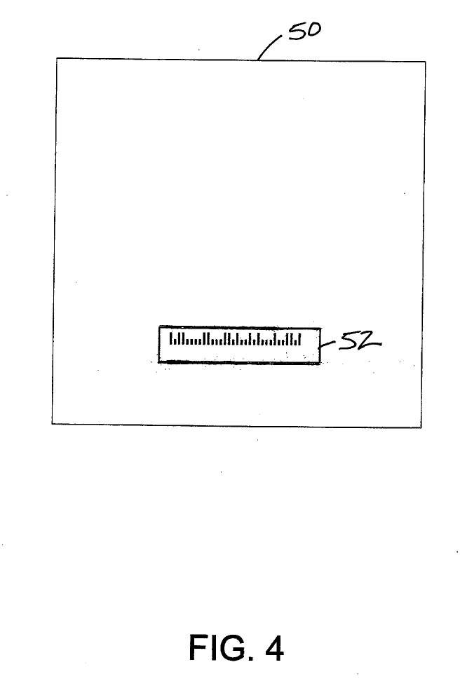

FIG. 4 illustrates a schematic diagram of an exemplary embodiment of a removable memory module 50 with a unique identifier 52. The unique identifier 52 is placed on the removable memory module 50 to associate patient information with the removable memory module. In an exemplary embodiment, the unique identifier 52 may be a barcode or other machine-readable representation of information. The unique identifier 52 may be scanned by an optical scanner or a barcode reader to determine the identity of the patient whose image data is stored on the removable memory module 50.

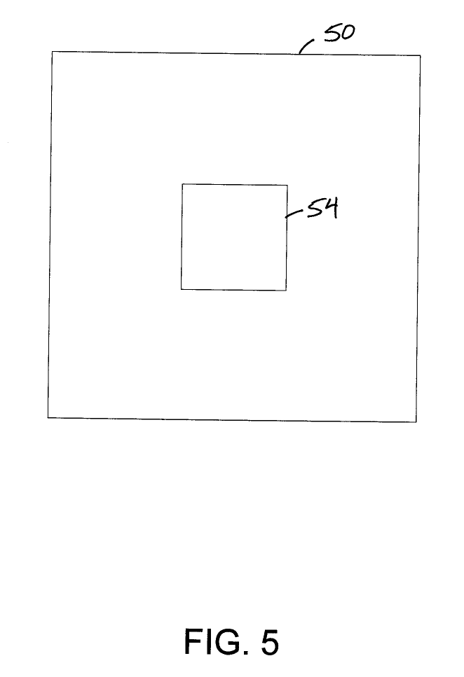

FIG. 5 illustrates a schematic diagram of an exemplary embodiment of a removable memory module 50 with a unique identifier 54. The unique identifier 54 is attached to the removable memory module 50 to associate patient information with the removable memory module. In an exemplary embodiment, the unique identifier 54 may be an RFID transponder or tag. The unique identifier 54 may be read by a RFID reader to determine the identity of the patient whose image data is stored on the removable memory module 50.

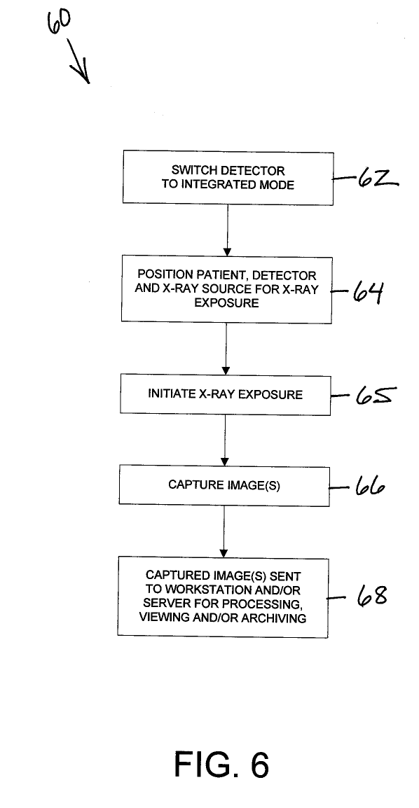

FIG. 6 illustrates a flow diagram of an exemplary embodiment of a method 60 of operation of a portable dual-mode digital X-ray detector in an integrated mode. The method 60 begins at step 62 by switching the portable dual-mode digital X-ray detector to the integrated mode. At step 64, the patient, detector and X-ray source are properly positioned for an X-ray exposure. A user initiates the X-ray exposure at step 65. At step 66, image data is captured by the detector. The captured image data is then transferred or sent to a workstation and/or a server for processing, viewing and/or archiving at step 68.

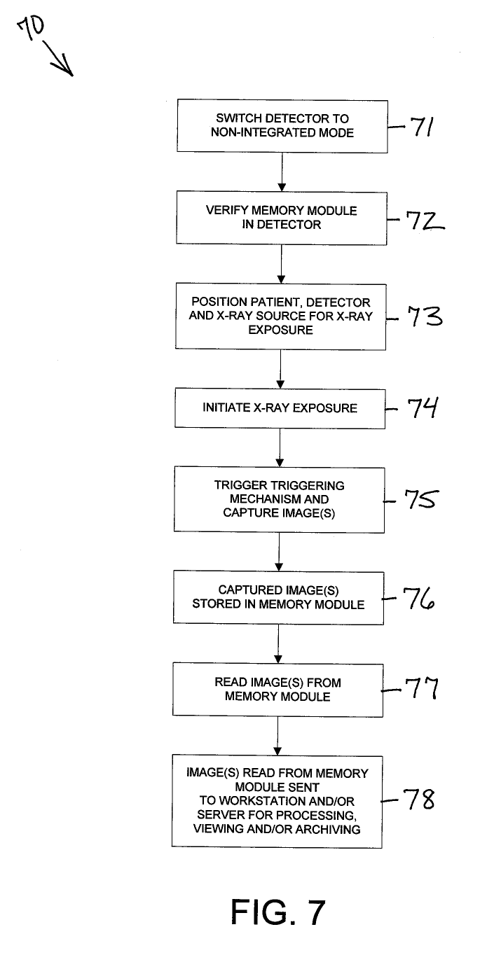

FIG. 7 illustrates a flow diagram of an exemplary embodiment of a method 70 of operation of a portable dual-mode digital X-ray detector in a non-integrated mode. The method 70 begins at step 71 by switching the portable dual-mode digital X-ray detector to the non-integrated mode. At least one memory module is inserted into the detector at step 72. Alternatively, a user may verify that at least one memory module is already installed in the detector. The at least one memory module may be a new memory module with full storage availability, or at least one memory module with sufficient storage availability. At step 73, the patient, detector and X-ray source are properly positioned for an X-ray exposure. A user initiates the X-ray exposure at step 74. At step 75, a triggering mechanism on the detector is triggered by detecting X-ray radiation from the X-ray source to initiate image capture by the detector. Image data is captured by the detector. The captured image data is stored in the at least one memory module at step 76. At step 77, image data read from the at least one memory module. In an exemplary embodiment, the at least one memory module is removed from the detector and the at least one memory module is associated with patient information by attaching a unique identifier to the at least one memory module. The unique identifier is used to associate patient information with the patient's image data stored within the at least one memory module. In this embodiment, a barcode reader or a RFID reader may be used to read the unique identifier in order to determine the identity of the patient whose image data is stored on the at least one memory module. The at least one memory module is taken to a memory reader to read the image data from the at least one memory module. The image data read from the at least one memory module is then transferred or sent to a workstation and/or a server for processing, viewing and/or archiving at step 78.

Several embodiments are described above with reference to drawings. These drawings illustrate certain details of exemplary embodiments that implement the systems and methods of this disclosure. However, the drawings should not be construed as imposing any limitations associated with features shown in the drawings.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communications protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the disclosure has been described with reference to various embodiments, those skilled in the art will appreciate that certain substitutions, alterations and omissions may be made to the embodiments without departing from the spirit of the disclosure. Accordingly, the foregoing description is meant to be exemplary only, and should not limit the scope of the disclosure as set forth in the following claims.

What is claimed is:

1. A portable dual-mode X-ray detector comprising:
a switching mechanism for switching the detector between an integrated mode and a non-integrated mode;
a triggering mechanism for use in the non-integrated mode;
a communications interface for use in the integrated mode; and
at least one memory module for storing image data.

2. The detector of claim 1, further comprising a battery for powering the detector.

3. The detector of claim 1, further comprising an indicator for indicating to a user whether the detector is in the integrated mode or the non-integrated mode.

4. The detector of claim 1, wherein the integrated mode is used for direct digital radiography (DDR).

5. The detector of claim 1, wherein the non-integrated mode is used for computed radiography (CR), in a manner similar to a CR imaging plate.

6. The detector of claim 1, wherein the switching mechanism is implemented through a manual switch.

7. The detector of claim 1, wherein the switching mechanism is implemented automatically.

8. The detector of claim 7, wherein the detector automatically switches to the integrated mode when the detector is coupled to a direct digital radiography (DDR) system, and automatically switches to the non-integrated mode when it is uncoupled from the DDR system.

9. The detector of claim 1, wherein the triggering mechanism is configured to initiate image capture in the detector.

10. The detector of claim 9, wherein the triggering mechanism is configured to terminate image capture in the detector.

11. The detector of claim 1, wherein the communications interface is a wired communications interface.

12. The detector of claim 1, wherein the communications interface is a wireless communications interface using a wireless communications protocol.

13. The detector of claim 1, wherein the at least one memory module is a removable memory module and includes a unique identifier for associating patient information with the image data stored on the at least one memory module.

14. The detector of claim 13, wherein the unique identifier is a barcode.

15. The detector of claim 13, wherein the unique identifier is a radio frequency identification (RFID) transponder.

16. A radiography system comprising:
an X-ray source;
a dual-mode portable X-ray detector capable of operating in an integrated mode and a non-integrated mode; and
a system controller coupled to the X-ray source and the dual-mode portable X-ray detector for controlling operation of the X-ray source and the dual-mode portable X-ray detector;
wherein the dual-mode portable X-ray detector is operating in the integrated-mode.

17. The radiography system of claim 16, wherein the detector is configured to receive data transfer timing signals from the system controller to initiate and terminate image capture in the detector.

18. A radiography system comprising:
an X-ray source;
a dual-mode portable X-ray detector capable of operating in an integrated mode and a non-integrated mode; and
a system controller coupled to the X-ray source for controlling operation of the X-ray source;
wherein the dual-mode portable X-ray detector is operating in the non-integrated-mode.

19. The radiography system of claim 18, wherein the detector includes a triggering mechanism configured to initiate and terminate image capture in the detector.

20. The radiography system of claim 18, wherein the detector includes at least one memory module for storing captured image data.

21. A method of operation of a portable dual-mode X-ray detector in an integrated mode comprising:
switching the portable dual-mode digital X-ray detector to an integrated mode;
positioning a patient, the detector, and an X-ray source for an X-ray exposure;
initiating the X-ray exposure;
capturing image data in the detector; and
transferring the captured image data to a workstation and/or a server for processing, viewing and/or archiving.

22. A method of operation of a portable dual-mode X-ray detector in a non-integrated mode comprising:
switching the portable dual-mode digital X-ray detector to a non-integrated mode;
positioning a patient, the detector, and an X-ray source for an X-ray exposure;
initiating the X-ray exposure;
capturing image data in the detector;
storing the captured image data in at least one memory module;
reading the captured image data stored on the at least one memory module; and
transferring the image data read from the at least one memory module to a workstation and/or a server for processing, viewing and/or archiving.

23. The method of claim 22, wherein the step of capturing image data is implemented by a triggering mechanism configured to initiate and terminate image capture in the detector.

24. The method of claim 22, wherein the at least one memory module is removable.

25. The method of claim 24, further comprising the step of removing the at least one removable memory module from the detector and taking it to a memory reader for reading the image data stored on the at least one removable memory module, and associating the at least one removable memory module with patient information by attaching a unique identifier to the at least one removable memory module, wherein the unique identifier associates the patient information with the patient's image data stored on the at least one removable memory module.
